(19) United States
(12) Patent Application Publication
(10) Pub. No.: US 2017/0032697 A1
(43) Pub. Date: Feb. 2, 2017

(54) TELLING TIME RULER

(71) Applicant: Debra J. Alibozek, Adams, MA (US)

(72) Inventor: Debra J. Alibozek, Adams, MA (US)

(21) Appl. No.: 15/059,973

(22) Filed: Mar. 3, 2016

Related U.S. Application Data
(60) Provisional application No. 62/197,317, filed on Jul. 27, 2015.

(51) Int. Cl. G09B 19/12

(52) U.S. Cl. CPC G09B 19/12

(57) ABSTRACT

Applicant has disclosed a method and apparatus for teaching young students “how to tell time” on an analog clock. In a preferred “method” embodiment, Applicant's invention comprises: inserting a ruler with twelve hinged sections (each containing indicia representing five intervals) into a substantially straight recessed channel in a first base; sliding hour, minute and second hands, located in a parallel thinner recessed channel in the base, along the twelve sections to help the student conceptualize minutes, hours and seconds; removing the ruler from the first base; pivoting each hinged section until the ruler's ends meet, whereupon the ruler's outer edge substantially forms a circle; placing the substantially “circular” ruler into a correspondingly shaped recess in a second base; and rotating hour, minute and second hands, about a pin in the second base, and around the pivoted sections to help the student conceptualize how to tell time on an analog clock.

### RELATED APPLICATION

This application claims priority to U.S. Provisional Patent Application, Ser. No. 62/197,317, filed Jul. 27, 2015. Applicant claims priority from that application. Applicant also incorporates by reference that application in its entirety.

### FIELD OF INVENTION

This invention deals with devices to teach young students how to tell time on an analog clock.

### BACKGROUND OF THE INVENTION

Learning how to tell time on an analog clock face can be a difficult feat. Conceptualizing the use of two different numbering systems—1 through 12 and 1 through 60—can be hard, especially at a young age. Various attempts have been made to create teaching aids for the time telling learning process. These attempts have resulted in devices of many forms, but have often failed to enable successful transfer of the learned time telling skill to analog clock faces.

Prior time telling teaching devices have used the same circular structure as the analog clock. See, e.g., U.S. Pat. No. 4,124,945 to Totten and U.S. Pat. No. 3,967,389 to Brooks. Some have incorporated new elements such as color coordination to teach the two different numbering systems, as described below. See, e.g., U.S. Pat. No. 4,124,945 to Totten.

Many devices have taken the approach of color coordination to teach the hour and minute scales independently on an analog clock face. For example, U.S. Pat. No. 3,702,507 to Romey discloses the use of color coordination between the time scales and their respective clock hands. Other devices color coordinate the “before” and “after” halves of the clock face to teach the minute measurements as “before” the hour and “after” the hour. See U.S. Pat. No. 3,131,489 to Alpert and U.S. Pat. No. 3,149,423 to Naples.

Another prior approach has been the physical separation of the minute, hour and second indicia. U.S. Pat. No. 3,670,428 to Hall, which discloses separating the indicia (minutes and hours) into two discs. U.S. Pat. No. 5,653,595 to Brown discloses the separation of the time scale indicia (i.e., minutes, hours and seconds) into three separate, size-varied rings, and stacking the rings upon one another with minute and hour hands at the center to form a “clock-like” structure. Another device has separated the minute, hour and second indicia into three different clock faces altogether. See U.S. Pat. No. 3,022,582 to Pitt. U.S. Pat. No. 6,071,124 to Ang et al. discloses the use of hidden gears to display the corresponding minute, hour and second hands separately on the face of the device, as the respective hands are rotated by the user.

Other prior approaches to time telling teaching devices have included: insertable pegs along the clock's minute indicia in order to teach minute counting. See U.S. Pat. No. 3,022,582 to Pitt.

However, all the aforementioned devices continue to use the same “clock-like” circular shape to teach time telling skills. Because the concept of a circular measuring system is itself confusing, it becomes difficult to master the fundamentals of time measurement. As a result, the approaches taken by current devices tend to add further to the confusion.

It would be beneficial to remove the confusing concept of the circular motion of clock-hands along two numbering systems when first teaching the basics of time measurement. Additionally, it would be beneficial for purposes of translating the learned time telling skill to analog clock faces to eliminate additional elements such as separate discs and faces for each time system.

It is therefore a primary object of the present invention to design a simple time telling teaching device that allows users to first easily grasp the concept of time measurement on two different simultaneous numbering scales, and then apply the skill to an analog clock face.

It is a more specific object to utilize a straight line measurement system to first teach multi-scale time measurement, and then transfer the skill to a circular measurement system representative of an analog clock face.

### SUMMARY OF THE INVENTION

Applicant has disclosed a tool for teaching time telling on an analog clock by first teaching time measurement and time telling concepts on a straight ruler and then applying the learned skills to the ruler in a substantially circular position.

In the preferred embodiment, Applicant's invention comprises: a ruler with twelve hinged sections each divided into five intervals; inserting the ruler in a straight position into a similarly shaped recessed channel in a base; sliding hour, minute and second hands in a slot parallel to the ruler and indicia on the base representing hours and minutes; removing the ruler from the recessed channel; pivoting the ruler so that the outer edge of the ruler is in a substantially circular position; placing the ruler into a similarly shaped recess in a second base; and rotating other hour, minute and second hands on a pivot pin located in the base at the center of the substantially circular ruler.

Applicant's invention provides the advantage of first teaching time measurement on a straight-line ruler. The student is better able to master the time telling and time measurement skills, and therefore successfully transfers the skills to an analog clock face.

### BRIEF DESCRIPTION OF THE DRAWINGS

The above objects and other advantages of the invention will become more readily apparent upon reading the following description and drawings, in which:

FIG. 1 depicts a perspective view of the “Telling Time Ruler” in a straight position, and an underlying first base with a similarly shaped recessed channel;

FIG. 2 depicts a perspective view of the preferred “Telling Time Ruler” in the straight position inserted into the recessed channel of the first base;

FIG. 3 depicts a perspective view of a single hinged section of the “Telling Time Ruler;”

FIG. 4 depicts a perspective view of the “Telling Time Ruler”, with its outside edge in a substantially circular position, and an underlying second base with a similarly shaped recess;

FIG. 5 depicts an alternate embodiment in which the “Telling Time Ruler”, while in the substantially circular position, is inserted into and removably attached to the recess of the second base;

FIG. 6 depicts a perspective view of the alternate embodiment showing the “Telling Time Ruler” in the straight position with the Velcro® strip on the bottom surface and the first base with a mating Velcro® strip;

FIG. 7 depicts a perspective view of the “Telling Time Ruler” in the straight position attached to the first base by Velcro®;

FIG. 8 depicts a perspective view of the “Telling Time Ruler” in the substantially circular position with the Velcro® strip on the bottom surface and the second base with the opposing half of the Velcro strip®; and

FIG. 9 depicts a perspective view of the “Telling Time Ruler” in the substantially circular position attached to the second base by Velcro®.

### DETAILED DESCRIPTION OF THE PREFERRED EMBODIMENT

Applicant has invented a teaching tool 100, and a related method, to help teach young students (e.g., 6-7 years old): how to tell time on an analog clock; and how to measure increments of time.

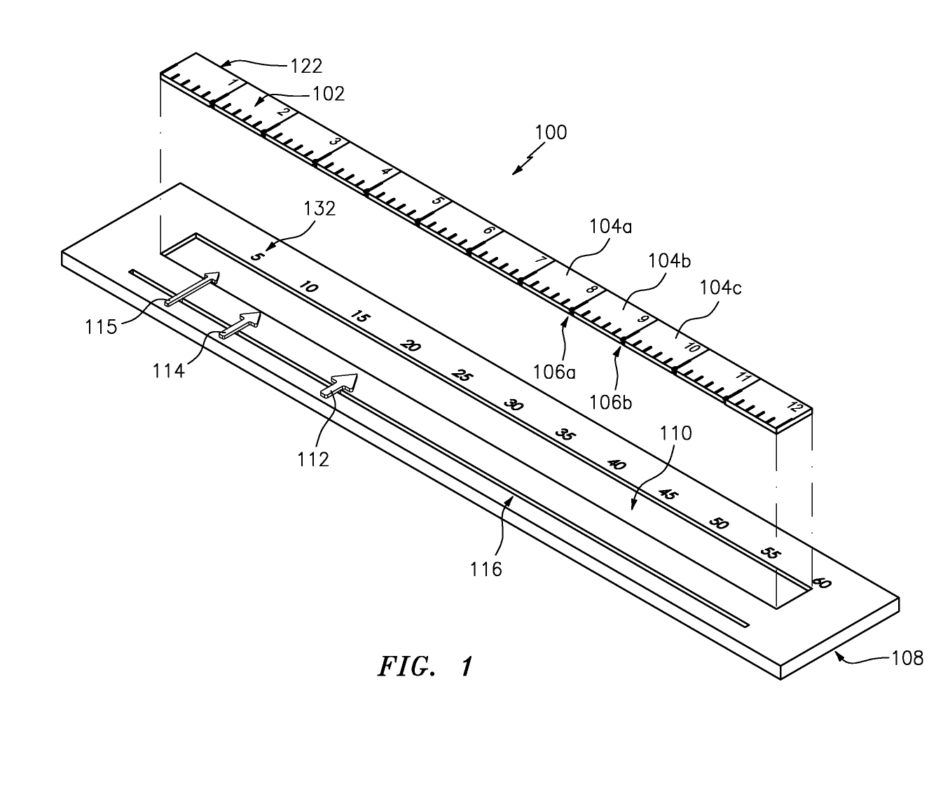

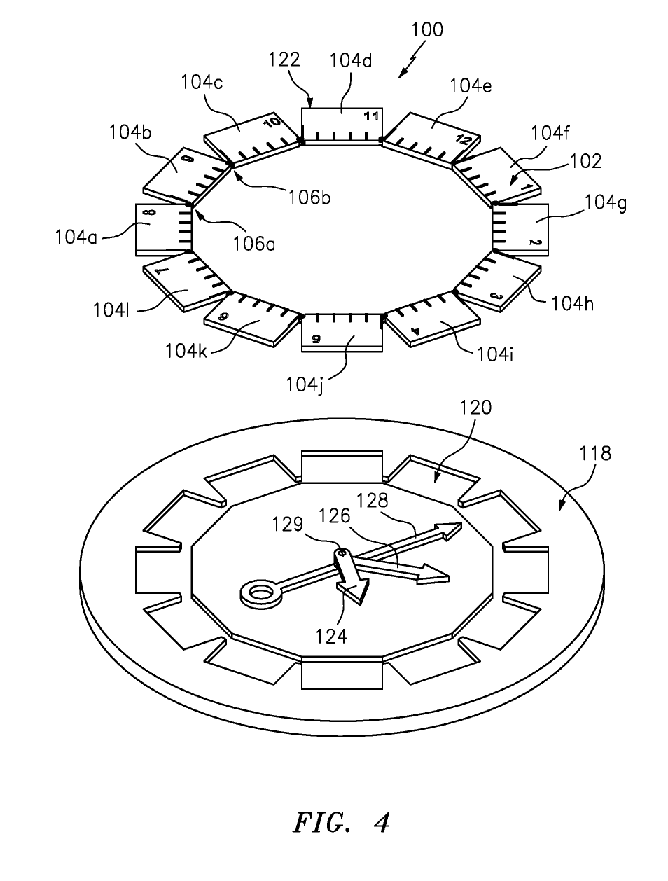

In the preferred embodiment, shown in FIGS. 1-5, the teaching tool 100 comprises: a one-foot ruler 102 (nicknamed the “Telling Time Ruler”) with twelve sections 104a, 104b, 104c, 104d, 104e, 104f, 104g, 104h, 104i, 104j, 104k, 104l, (see FIG. 4) with contiguous individual sections (e.g., 104a, 104b and 104c) hinged (e.g., 106a, 106b—see FIG. 3); a first base 108 having a substantially straight recessed channel 110 into which the straight or straightened ruler 102 can be inserted; three slidable pointers 112, 114, 115 housed in a slot 116 (i.e., a thinner recessed channel) in the first base 108, which is parallel to channel 110; and, a second base 118 having a recess 120 into which the same ruler 102 can be inserted, at another time, after the ruler sections 104a-104l have been pivoted so that an outer edge 122 of the ruler 102 substantially forms a circle; and three rotatable pointers (i.e., hour hand 124, minute hand 126, and second hand 128) mounted on a pivot pin 129, wherein the ruler 102 surrounds the pivot pin 129 after the ruler is inserted into the recess 120.

There are twelve integers (1 through 12), one per ruler section (e.g., 104a, 104b and 104c). Each ruler section is broken down into fifths, represented by four identical vertical lines and a longer vertical line for the next integer. See, e.g., the lines at 130 in FIG. 3.

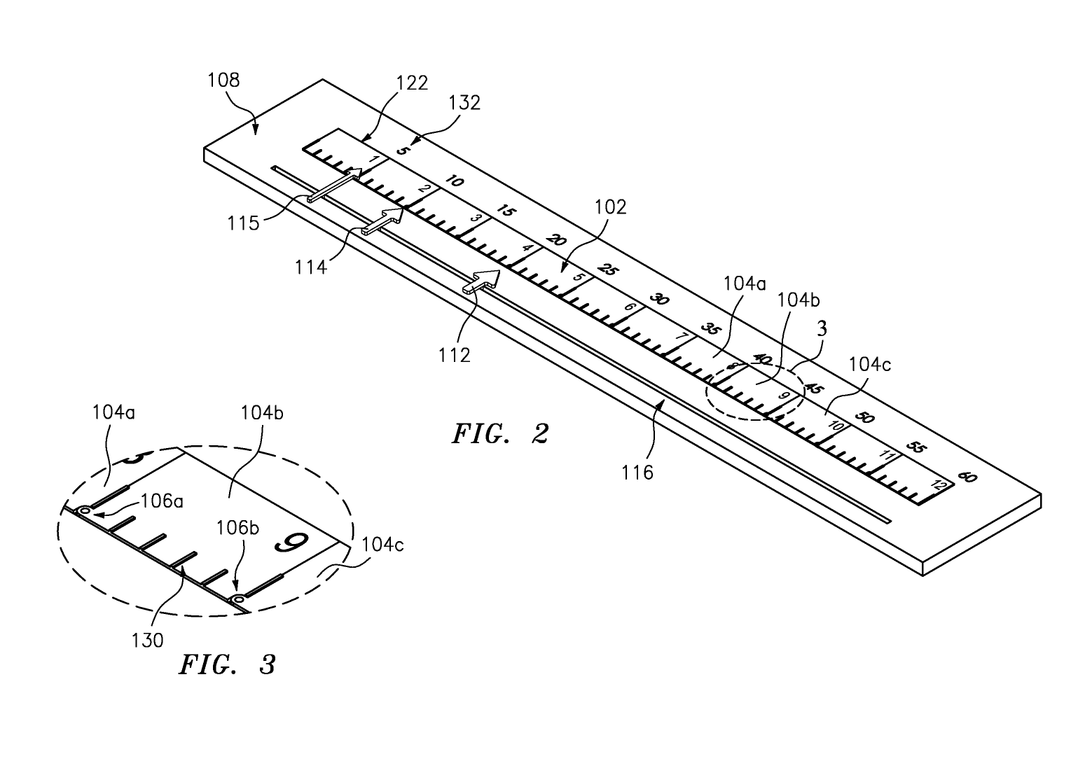

The students are taught first “how to tell time” when the Telling Time Ruler 102 is straight. The ruler 102 is placed or inserted into the recessed channel 110 of the first base 108. Preferably the channel 110 is correspondingly shaped like the straight ruler 102 including the hinges. See FIGS. 1 and 2. The base 108 also has: indicia—namely five-minute intervals (e.g., at 132) up to sixty minutes—inscribed “above” the stored ruler 102; and the slot 116, which is longitudinal. Slot 116—in which the three pointers (i.e., an hour hand 112, a longer minute hand 114, and a thinnest and longest second hand 115) slide—is also parallel to and “below” the stored ruler 102. The students learn to count time from one point to another point, on the straight ruler 102, using the slidable hour, minute and second hands 112, 114, 115.

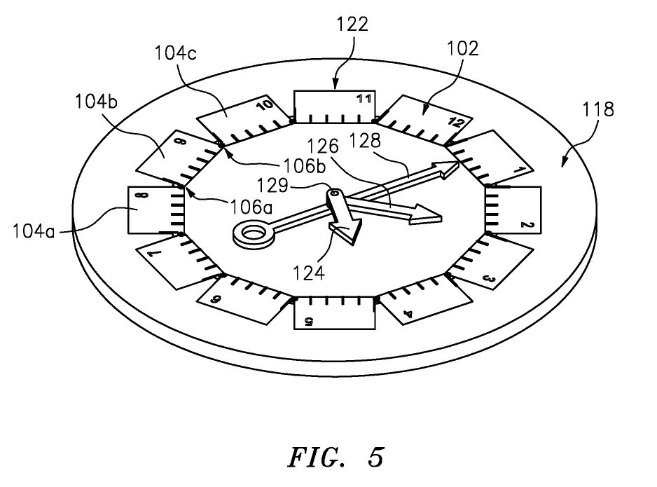

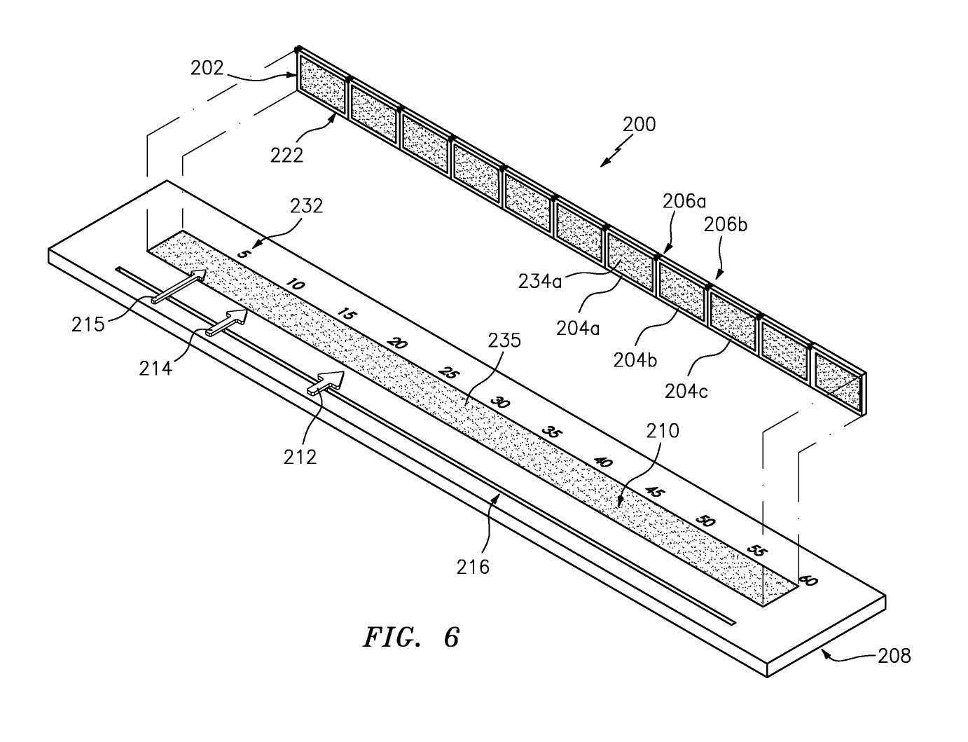

Once this concept is mastered, the ruler 102 is lifted up from the first base 108; the ruler sections 104a-104l are pivoted, via the hinges (e.g., 106a, 106b), so that the outer edge 122 of the ruler 102 is substantially circular; and the “circular” ruler (see FIG. 4) is laid into a similarly shaped recess 120 of the second, preferably circular, base 118 (see FIG. 5). When laid into the recess 120, the so-called circular ruler 102 surrounds hour, minute and second hands 124, 126, 128 which are pinned (see pin 129) onto the center of the second base 118 (see FIG. 5). Then the students learn the concept of telling the hour, minute, and second while focusing on a “clock like” ruler.

The same integers and vertical lines (e.g., at 130) in the ruler 102 can be used to teach the students about the concept of seconds, after the students have learned about minutes and hours.

Though not shown in the drawings, the integers on ruler 102 and base 108 can be color-coded to help the students understand which numbers to read. Similarly, the slidable pointers 112, 114, 115 and 124, 126, 128 can be color-coded. For example, blue can be used for the hour pointers 112, 124 and numbers 1-12 on 100; red can be used for the minute pointers 114, 126 and numbers 1-60 on 108; and green can be used for the second hands 115, 128.

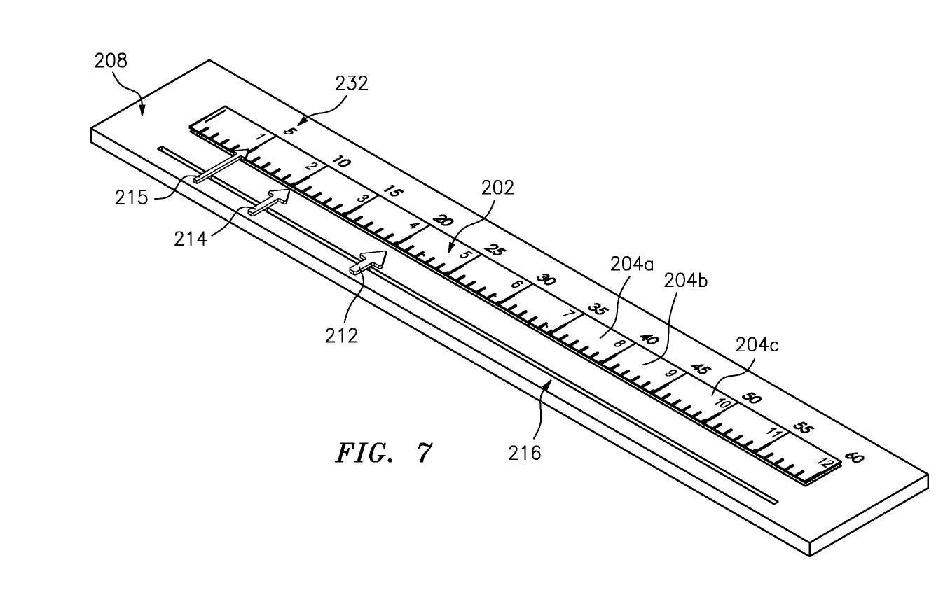

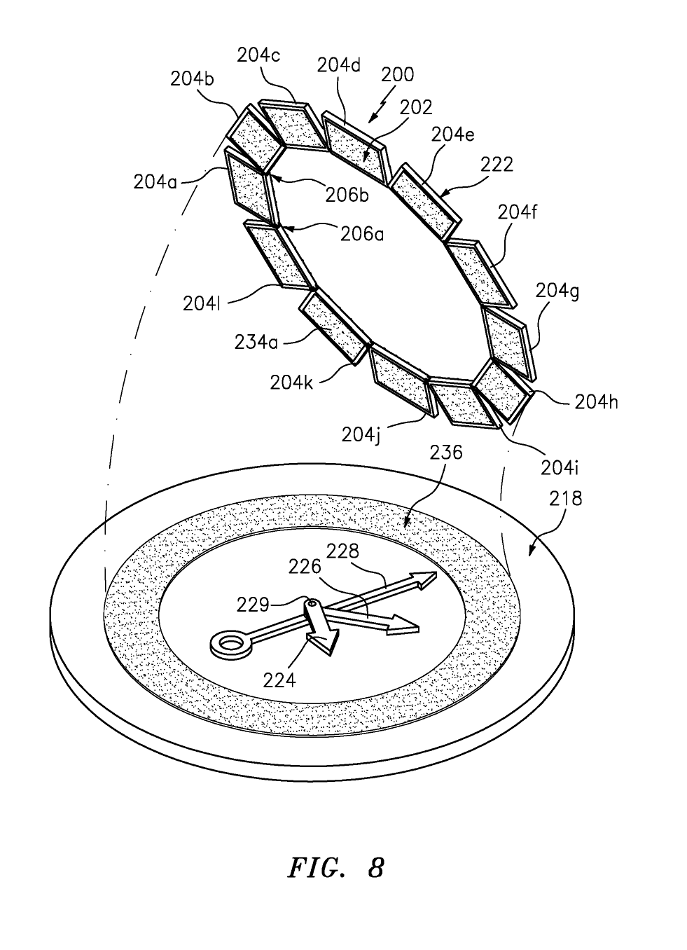

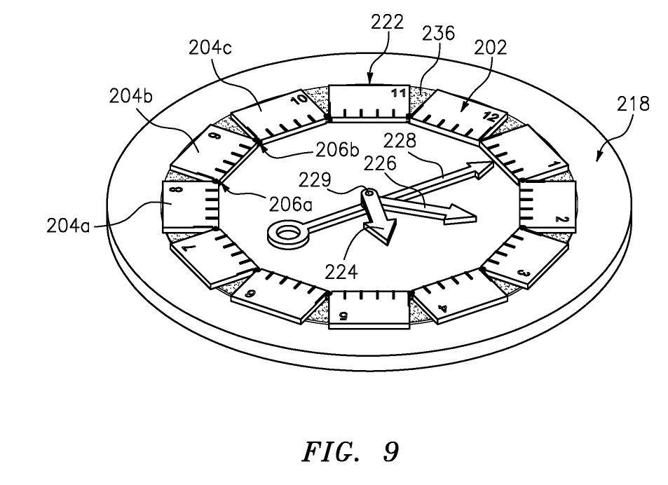

FIGS. 6-8 depict an alternate embodiment 200 of the telling time tool. Like parts in FIGS. 1-5 have been designated by the prefix 200. For example, the slot 116 of FIGS. 1-5 is represented as 216 in FIGS. 6-8.

In this alternate embodiment 200, the Telling Time Ruler 202 is attached to underlying first and second bases 208, 218 by Velcro® fasteners (e.g., multiple Velcro® strips such as 234a on the back of the twelve sections 204a-204l of the Time Telling Ruler 202, the single straight strip 235 on the first base 208, and the circular strip 236 on the second base 218) instead of the ruler being inserted into recessed channels.

It should be understood by those skilled in the art that obvious structural modifications could be made without departing from the spirit or scope of the invention. For example, though not preferred, there could be two rulers rather than one involved: a straight non-hinged ruler could be permanently affixed to a base, like first base 108, having indicia (e.g., five-minute/five-second intervals) and slidable hour, minute and second hands, like 112, 114, 115; and a hinged ruler permanently affixed to a circular base, like second base 118, having pinned hour, minute and second hands, like 124, 126, 128. Accordingly, reference should be made primarily to the appended claims rather than the foregoing claims to determine the scope of the invention.

I claim:

1. A tool for teaching time telling comprising:
a. a ruler with twelve sections wherein:
i. contiguous sections are connected by hinges; and
ii. the ruler is substantially straight;
b. a first base having a substantially straight first recessed channel into which the ruler is removably inserted; and
c. at least one slidable pointer is located in a second recessed channel in the first base, wherein the second channel is parallel to the first channel.

2. The tool of claim 1 further comprising:
a. a second base having a recess into which the ruler can be removably inserted, wherein an outer edge of the ruler substantially forms a circle when the ruler is inserted into the recess; and
b. at least one rotatable pointer attached to a pivot pin in the second base, wherein the ruler surrounds the least one rotatable pivot pin, when the ruler is inserted into the recess.

3. The tool in claim 1 wherein each of the twelve sections contains indicia representing five intervals.

4. A tool for teaching time telling comprising:
a. a ruler with twelve sections wherein:
i. contiguous sections are connected by hinges; and
ii. the ruler is substantially straight;
b. a first base to which the ruler is removably attached; and
c. at least one slidable pointer is located in a recessed channel in the first base, wherein the channel is parallel to the longitudinal axis of the ruler.

5. The tool of claim 4 further comprising:
a. a second base to which the ruler can be removably attached, wherein an outer edge of the ruler substantially forms a circle when the ruler is attached to the second base; and
b. at least one rotatable pointer attached to a pivot pin in the second base, wherein the ruler surrounds the at least one rotatable pivot pin when the ruler is attached to the second base.

6. The tool in claim 4, wherein each of the twelve sections contains indicia representing five intervals.

7. A method of teaching time telling comprising:
a. inserting a ruler with twelve sections into a first channel of a first base wherein:
i. contiguous sections of the ruler are connected by hinges; and
ii. the ruler is substantially straight; and
b. sliding at least one pointer in a second channel in the first base along the longitudinal axis of the ruler.

8. The method of claim 7 further comprising the following steps:
a. removing the ruler from the first base;
b. pivoting the hinged sections of the ruler so that the outer edge of the ruler substantially forms a circle;
c. after step b, inserting the ruler into a correspondingly shaped second channel in a second base; and
d. rotating at least one pointer on a pivot pin mounted in the second base, wherein the ruler surrounds the pivot pin.

9. The ruler in claim 8, wherein each of the twelve sections contains indicia representing five intervals.
